(19) United States
(12) Patent Application Publication
(10) Pub. No.: US 2024/0046070 A1
(43) Pub. Date: Feb. 8, 2024

(54) CONTROLLING AGENTS USING AUXILIARY PREDICTION NEURAL NETWORKS THAT GENERATE STATE VALUE ESTIMATES

(71) Applicant: DeepMind Technologies Limited, London (GB)

(72) Inventors: Muhammad Zaheer, Edmonton (CA); Joseph Varughese Modayil, Edmonton (CA)

(21) Appl. No.: 18/230,056

(22) Filed: Aug. 3, 2023

Related U.S. Application Data
(60) Provisional application No. 63/395,182, filed on Aug. 4, 2022.

(51) Int. Cl. G06N 3/045; G06N 3/092

(52) U.S. Cl. CPC G06N 3/045; G06N 3/092

(57) ABSTRACT

Method, system, and non-transitory computer storage media for selecting actions to be performed by an agent to interact with an environment to perform a main task by for each time step in a sequence of time steps: receiving a set of features representing an observation; for each of one or more auxiliary prediction neural networks, generating a state value estimate for the current state of the environment relative to a corresponding auxiliary reward that measures values of a corresponding target feature from the set of features representing the observations for the sequence of time steps; processing an input comprising a respective intermediate output generated by each auxiliary neural network at the time step using an action selection neural network to generate an action selection output; and selecting the action to be performed by the agent at the time step using the action selection output.

### CROSS REFERENCE TO RELATED APPLICATION

This application claims the benefit of U.S. Provisional Application No. 63/395,182, filed Aug. 4, 2022, the contents of which is incorporated by reference herein.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent performing a main task in an environment.

According to a first aspect, there is provided a method performed by one or more computers for selecting actions to be performed by an agent to interact with an environment to perform a main task, the method comprising, for each time step in a sequence of time steps: receiving an observation comprising a set of features, wherein the observation characterizes a current state of the environment at the time step; for each of one or more auxiliary prediction neural networks: determining an auxiliary input to the auxiliary prediction neural network, wherein the auxiliary input comprises a proper subset of the set of features of the current observation; processing the auxiliary input using the auxiliary prediction neural network, wherein: the auxiliary prediction neural network is configured to generate a state value estimate for the current state of the environment relative to a corresponding auxiliary reward; and the auxiliary reward for the time step is based on a value of a corresponding target feature from the set of features at the time step; processing an input comprising a respective intermediate output generated by each auxiliary prediction neural network at the time step using an action selection neural network to generate an action selection output; and selecting the action to be performed by the agent at the time step using the action selection output.

Throughout this specification, an intermediate output of a neural network (e.g., an auxiliary prediction neural network) refers to an output generated by one or more hidden layers of the neural network.

The subject matter described in this specification can be implemented in particular embodiments so as to realize one or more of the following advantages.

The system described in this specification can select actions to be performed by an agent interacting with an environment using an action selection neural network and one or more auxiliary prediction neural networks. Each auxiliary prediction neural network is configured to process an input set of features that is a proper subset of the features in an observation of the environment to generate a state value estimate relative to an auxiliary reward that is specified by a “target” feature in the observation. That is, each auxiliary prediction neural network performs an auxiliary state value estimation task for an auxiliary reward specified by a corresponding target feature in the observation. At each time step, the system provides intermediate outputs generated by the auxiliary prediction neural networks, state value estimates generated by the auxiliary prediction neural networks, or both, as inputs to the action selection neural network for use in selecting the action to be performed by the agent. The intermediate outputs and state value estimates generated by the auxiliary prediction neural networks provide rich and informative feature representations that enhance the ability of the agent to effectively interact with the environment, e.g., to perform a main task in the environment.

The system can dynamically update the structure of the state value estimation predictions performed by the auxiliary prediction neural networks to enhance the information content and relevance of the feature representations (e.g., intermediate outputs and state value estimates) generated by the auxiliary prediction neural networks. For instance, the system can adaptively modify which features are designated as target features, i.e., that define auxiliary rewards for the state value estimates generated by the auxiliary prediction neural networks. In particular, the system can identify which features are more predictive of main task rewards, e.g., that characterize progress of the agent toward performing the main task, and then preferentially designate these features as target features. As another example, the system can adaptively modify which features are designated as being included in the input to an auxiliary prediction neural network, e.g., by identifying and preferentially selecting features that are more relevant to the state value estimation task being performed by the auxiliary prediction neural network. The system can thus automatically discover auxiliary prediction tasks that are relevant to the main task and dynamically update the auxiliary predictions over time to enable the generation of feature representations (i.e., using the auxiliary prediction neural networks) that improve the performance of the agent on the main task.

Providing intermediate outputs and/or state value estimates generates by the auxiliary prediction neural networks as inputs to the action selection neural network can (in some cases) enable the agent to perform tasks more efficiently (e.g., over fewer time steps) than would otherwise be possible. In particular, the action selection neural network can leverage the rich and informative feature representations provided by the intermediate outputs and/or state value estimates generated by the auxiliary prediction neural networks to master environment and tasks with greater efficiency. Moreover, jointly training the action selection neural network and the auxiliary prediction neural networks can allow the action selection neural network to achieve an acceptable performance over fewer training iterations, using less training data, or both, thus enabling reduced consumption of computational resources, e.g., memory and computing power.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example reinforcement learning system.

FIG. 2 is a flow diagram of an example process for selecting actions to be performed by an agent to interact with an environment to perform a main task

FIG. 3 is a flow diagram of an example process for updating target features and proper subsets of features for auxiliary neural networks FIG. 4A shows an example process for selecting a subset of features.

FIG. 4B shows an example updated feature vector.

FIG. 5 shows an example of updating data defining respective target features for auxiliary prediction neural networks.

FIG. 6 shows an example of updating data defining a proper subset of features for auxiliary prediction neural networks.

FIG. 7-10 show graphs illustrating the performance of the process of FIG. 2 compared to other methods on various environment sizes.

Like reference numbers and designations in the various drawings indicate like elements.

### DETAILED DESCRIPTION

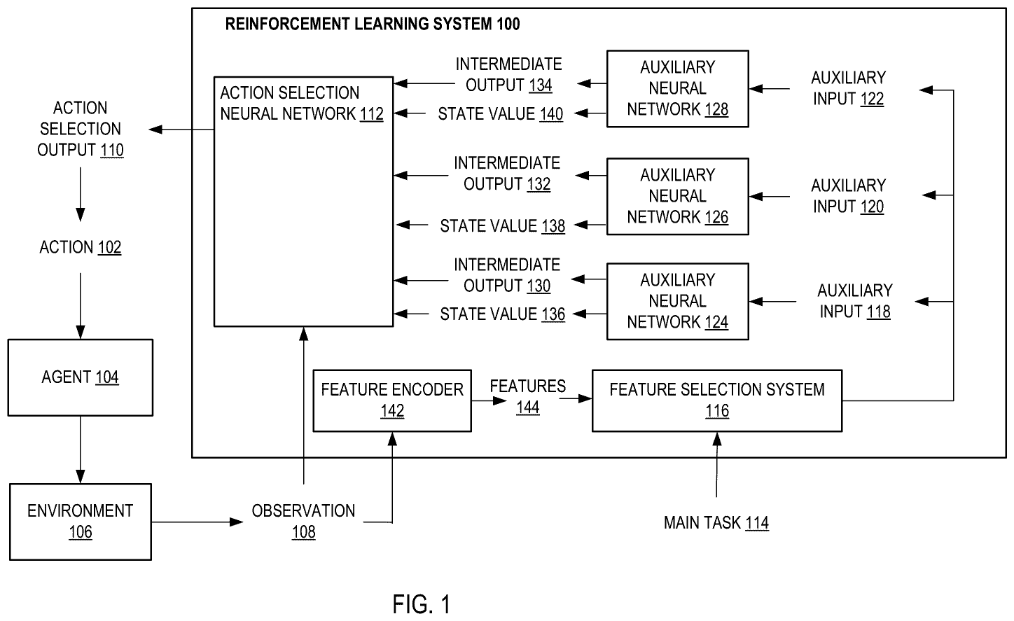

FIG. 1 shows an example reinforcement learning system 100. The reinforcement learning system 100 is an example of a system implemented as computer programs on one or more computers in one or more locations in which the systems, components, and techniques described below are implemented.

The reinforcement learning system 100 selects actions 102 to be performed by an agent 104 interacting with an environment 106 at each of multiple time steps in order to cause the agent to perform a main task 114. As one example, a main task 114 to be performed by the agent can comprise a task to control a robot. As another example, a main task 114 to be performed by the agent can comprise a task to manufacture a product.

In order for the agent 104 to interact with the environment 106, the system 100 receives an observation 108 characterizing the current state of the environment 106, e.g., an image of the environment, and selects an action 102 to be performed by the agent 104 in response to the received data.

The observation 108 can be represented as a set of features 144 that characterize the environment 106. Each feature can be represented, e.g., as one or more numerical values. For example, for an observation that includes an image, the set of features 144 representing the observation can include a respective feature representing the intensity of each channel of each pixel of the image. As another example, for an observation that includes joint position data for a mechanical agent, the set of features 144 representing the observation can include a respective feature representing the position/angle of one or more joints of the mechanical agent.

In some implementations, the features 144 are the output of a feature encoder 142. The feature encoder processes the original observation 108 to generate the features 144. The output of the feature encoder 142 can include one or more embeddings. For example, each feature can be represented as an embedding vector. As another example, each feature can be represented as a single value from an embedding vector. Each embedding can be a ordered collection of numerical values, e.g., a vector, matrix, or other tensor of numerical values.

In some implementations, the environment 106 is a simulated environment and the agent 104 is implemented as one or more computer programs interacting with the simulated environment. For example, the simulated environment may be a video game and the agent may be a simulated user playing the video game. As another example, the simulated environment may be a motion simulation environment, e.g., a driving simulation or a flight simulation, and the agent is a simulated vehicle navigating through the motion simulation environment. In these implementations, the actions may be control inputs to control the simulated user or simulated vehicle.

In some other implementations, the environment 106 is a real-world environment and the agent 104 is a mechanical agent interacting with the real-world environment. For example, the agent may be a robot interacting with the environment to accomplish a specific task. As another example, the agent may be an autonomous or semi-autonomous vehicle navigating through the environment. In these implementations, the actions may be control inputs to control the robot or the autonomous vehicle. In some of these implementations, the observations 108 may be generated by or derived from sensors of the agent 104. For example, the observations 108 may be captured by a camera of the agent 104. As another example, the observations 108 may be derived from data captured from a laser sensor of the agent 104. As another example, the observations 108 may be hyperspectral images captured by a hyperspectral sensor of the agent 104.

The system 100 uses an action selection neural network 112 in selecting actions to be performed by the agent 104 in response to observations 108 at each time step. The action selection neural network 112 can have any appropriate neural network architecture, e.g., including any appropriate types of neural network layers in any appropriate number (e.g., 5 layers, 10 layers, or 20 layers) and connected in any appropriate configuration. As a particular example, when the features of the observation 108 are pixel values, the action selection neural network 112 can be a vision transformer neural network or a convolutional neural network. As another example, when the features of the observation 108 are, e.g., the outputs of the feature encoder or are lower-dimensional values, e.g., proprioceptive sensor data, the neural network 112 can be a multi-layer perceptron (MLP) or a transformer neural network.

In particular, the action selection neural network 112 is configured to receive an input that includes either the observation 108 or the features 144 representing the observation and to process the input in accordance with a set of parameters, referred to in this specification as action selection neural network parameters, to generate an action selection output 110 that the system 100 uses to determine an action 102 to be performed by the agent 104 at the time step. For example, the action selection output 110 may be a probability distribution over the set of possible actions. As another example, the action selection output can be a prediction of the reward at the next time step. As another example, the action selection output 110 may be a Q-value that is an estimate of the long-term time-discounted reward that would be received if the agent 104 performs a particular action in response to the observation 108. As another example, the action selection output 110 may identify a particular action that is predicted to yield the highest long-term time-discounted reward if performed by the agent in response to the observation.

At each time step, the reinforcement learning system 100 receives a main task reward based on the current state of the environment 106 and the action 102 of the agent 104 at the time step.

Generally, the main task reward is a scalar numerical value and characterizes the progress of the agent 104 towards completing the main task.

As a particular example, the main task reward can be a sparse binary reward that is zero unless the task is successfully completed as a result of the action being performed, i.e., is only non-zero, e.g., equal to one, if the task is successfully completed as a result of the action performed.

As another particular example, the main task reward can be a dense reward that measures a progress of the agent towards completing the task as of individual observations received during the episode of attempting to perform the task, i.e., so that non-zero main task reward can be and frequently are received before the task is successfully completed.

In general, the system 100 or another training system trains the action selection neural network 112 to generate action selection outputs 110 that maximize the expected main task reward received by the system 100, by using a reinforcement learning technique to iteratively adjust the values of the action selection neural network parameters. The system can use any appropriate reinforcement learning technique, e.g., a Q-learning technique, an actor-critic technique, and can train the neural network 112 off-policy or on-policy.

In addition to the action selection neural network 112, the system 100 additionally includes one or more auxiliary prediction neural networks 124, 126, and 128. At each time step, each of the auxiliary prediction neural networks 124, 126, and 128 processes a respective auxiliary input 118, 120, and 122 to generate a respective intermediate output 130, 132, and 134. An intermediate output of a neural network (e.g., an auxiliary prediction neural network) refers to an output generated by one or more hidden layers of the neural network.

Each auxiliary prediction neural network 124, 126, and 128 can have any appropriate neural network architecture, e.g., including any appropriate types of neural network layers in any appropriate number (e.g., 5 layers, 10 layers, or 20 layers) and connected in any appropriate configuration. As a particular example, the auxiliary prediction neural networks 124, 126, and 128 can all be multilayer perceptron neural networks.

Each auxiliary prediction neural network 124, 126, and 128 is configured to process an input set of features 118, 120, and 122 that is a proper subset of the features in the observation 108, i.e., includes less than all of the features in the observation 108, of the environment 106 to generate a state value estimate 136, 138 and 140 relative to an auxiliary reward that is specified by a “target” feature in the observation. Each auxiliary prediction neural network 124, 126, and 128 can be associated with a different target feature, and thus the auxiliary reward for each auxiliary prediction neural network can be specified by a different target feature. Furthermore, the input set of features 118, 120, and 122 for each auxiliary prediction neural network 124, 126, and 128 can include different input features for each auxiliary prediction neural network. The features included in the proper subset of the features can be selected based on the target feature for the particular auxiliary prediction neural network. That is, each auxiliary prediction neural network 124, 126, and 128 performs an auxiliary state value estimation task for an auxiliary reward specified by a corresponding target feature in the observation.

A state value estimate can define the value of a current state of the environment relative to a corresponding auxiliary reward. For example, a state value estimate can define an estimate of a cumulative measure of the corresponding auxiliary reward for an auxiliary prediction neural network 124, 126, and 128 to be received over future time steps.

At each time step, the action selection neural network 112 receives, as additional inputs, i.e., in addition to the observation 108 or the features generated from the observation 108, intermediate outputs 130, 132, and 134 generated by the auxiliary prediction neural networks 124, 126, and 128, state value estimates 136, 138, and 140 generated by the auxiliary prediction neural networks, or both as inputs for use in selecting the action 102 to be performed by the agent 104.

The intermediate outputs 130, 132, and 136 and state value estimates 136, 138, and 140 generated by the auxiliary prediction neural networks 124, 126, and 128 provide rich and informative feature representations that enhance the ability of the agent to effectively interact with the environment 106, e.g., to perform a main task 114 in the environment.

The reinforcement learning system 100 can dynamically update the structure of the state value estimation predictions performed by the auxiliary prediction neural networks to enhance the information content and relevance of the feature representations (e.g., intermediate outputs 130, 132, and 134 and state value estimates 136, 138, and 140) generated by the auxiliary prediction neural networks 124, 126, and 128.

For instance, the system 100 can adaptively modify which features are designated as target features, i.e., that define auxiliary rewards for the state value estimates generated by the auxiliary prediction neural networks, for one or more of the auxiliary neural networks 124. In particular, the system can identify which features are more predictive of main task rewards, e.g., that characterize progress of the agent toward performing the main task 114, and then preferentially designate these features as target features.

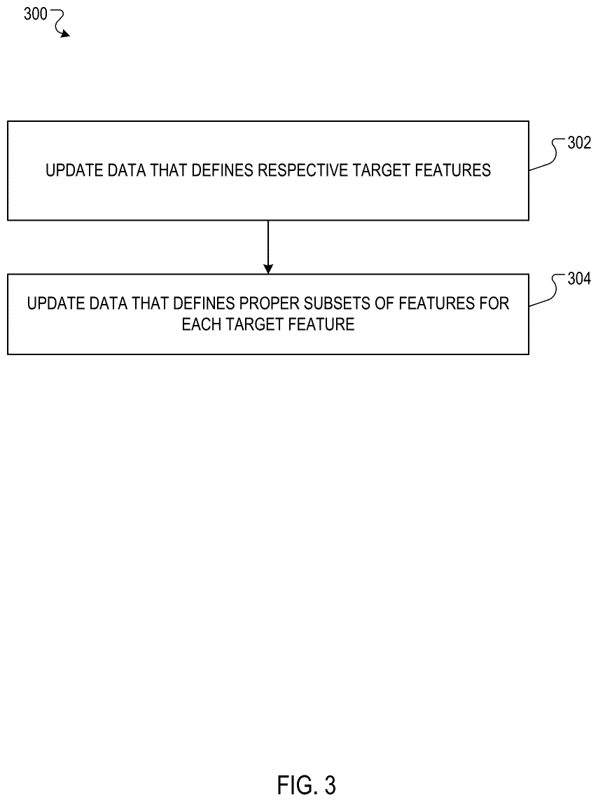

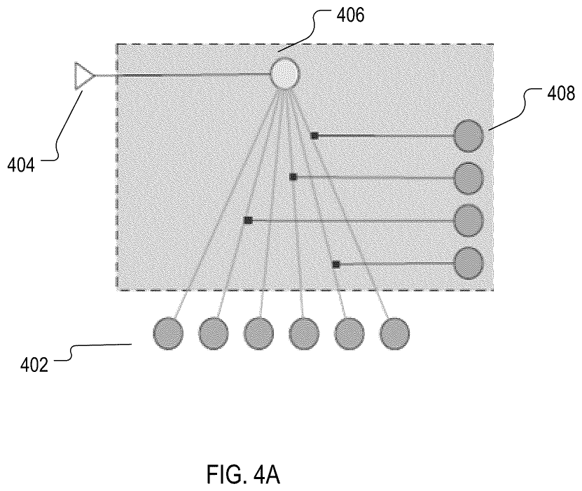

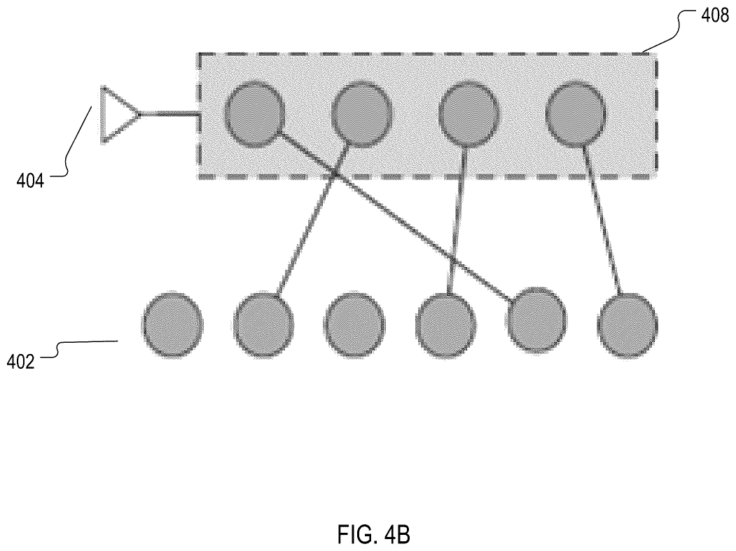

After every N time steps in the sequence of time steps, the reinforcement learning system can use a feature selection system 116 to update data that defines the respective target features that specify the auxiliary rewards for the auxiliary prediction neural networks 124, 126, and 128. In some examples, the feature selection system 116 receives an embedding 144 of features from the feature encoder 142. Updating the respective target features is further described below with reference to FIGS. 3 and 4.

The system 100 trains the auxiliary prediction neural networks 124, 126, and 128 jointly during the training of the action selection neural network 112. In particular, the system trains each auxiliary neural network 124, 126, and 128 on some or all of the same training data as the auxiliary prediction neural network 112 but on an objective function that measures errors between predicted state value estimates and ground truth state value estimates

In some implementations, the reinforcement learning system 100 can retrain the action selection neural network 112 jointly with the auxiliary prediction neural networks 124, 126, and 128 every time that the feature selection system 116 updates the data that defines the respective target features that specify the auxiliary rewards for the auxiliary prediction neural networks 124, 126, and 128.

In other implementations, the reinforcement learning system 100 can retrain the action selection neural network 112 jointly with the auxiliary prediction neural networks 124, 126, and 128 at any variety of intervals.

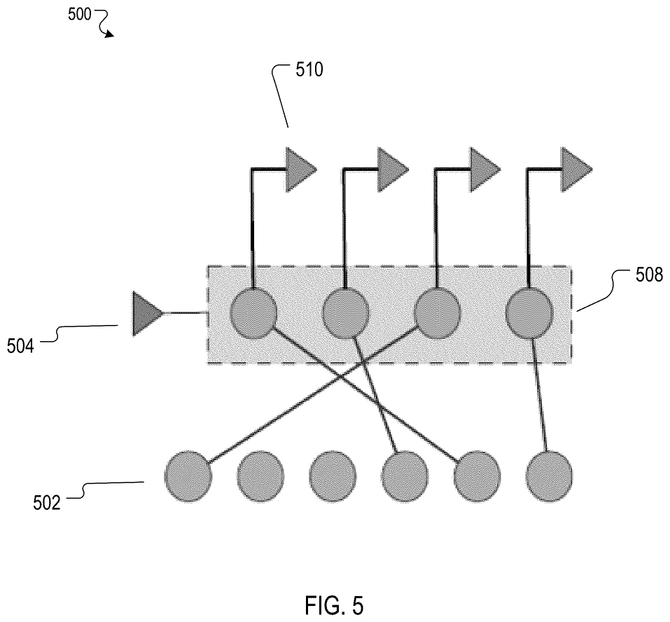

The reinforcement learning system 100 can use the feature selection system 116 to generate the respective auxiliary inputs 118, 120, and 122. Each auxiliary input 118, 120, and 122 includes a proper subset of the set of features for the current observation 108 that correspond to a respective target feature. At each time step, the feature selection system 116 can update the data that defines the proper subset of the set of features for each auxiliary prediction neural network 124, 126, and 128. Updating a proper subset of features is further described below with reference to FIG. 5.

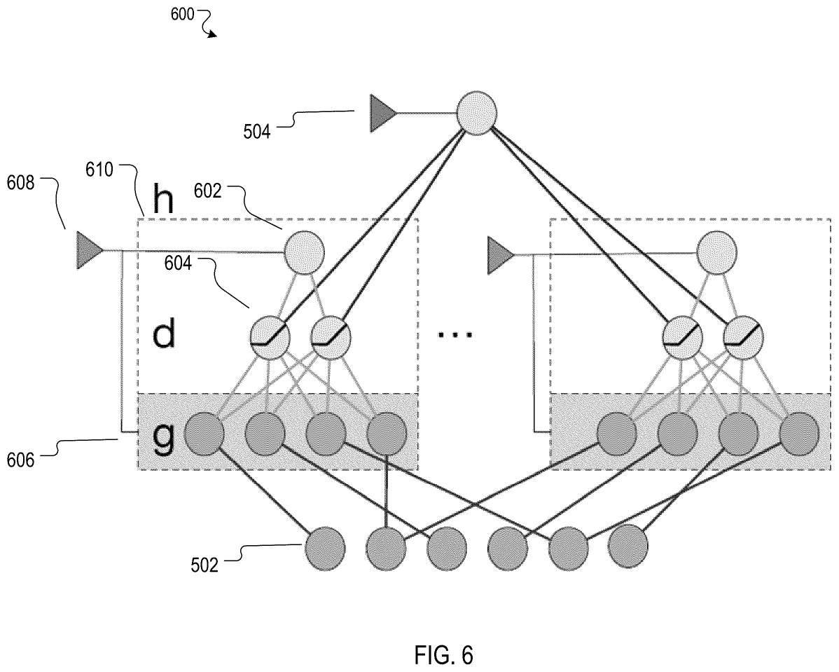

The reinforcement learning system 100 can adaptively modify which features are designated as being included in the input to an auxiliary prediction neural network 124, 126, and 128, e.g., by identifying and preferentially selecting features that are more relevant to the state value estimation task being performed by the auxiliary prediction neural network. The system 100 can thus automatically discover auxiliary prediction tasks that are relevant to the main task 114 and dynamically update the auxiliary predictions over time to enable the generation of feature representations (i.e., using the auxiliary prediction neural networks 124, 126, and 128) that improve the performance of the agent on the main task 114. Discovering auxiliary prediction tasks that are relevant to the main task is further described below with reference to FIG. 6.

In some implementations, the reinforcement learning system 100 can retrain the action selection neural network 112 jointly with the auxiliary prediction neural networks 124, 126, and 128 every time that the feature selection system 116 updates the data that defines the proper subset of features that are designated to be included as input to the auxiliary prediction neural networks 124, 126, and 128.

In other implementations, the reinforcement learning system 100 can retrain the action selection neural network 112 jointly with the auxiliary prediction neural networks 124, 126, and 128 at any variety of intervals.

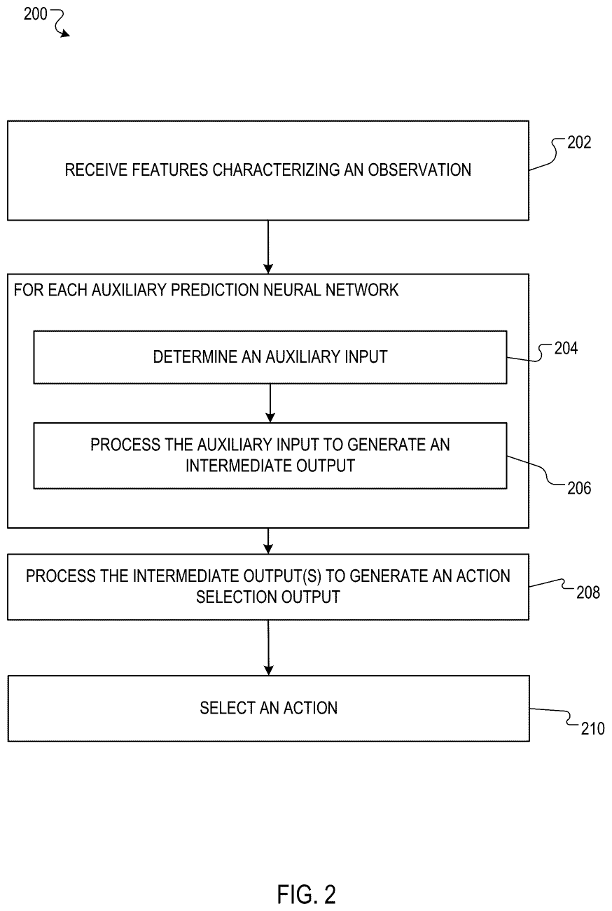

FIG. 2 is a flow diagram of an example process 200 for selecting actions to be performed by an agent to interact with an environment to perform a main task. For convenience, the process 200 will be described as being performed by a system of one or more computers located in one or more locations. For example, a reinforcement learning system, e.g., the reinforcement learning system 100 of FIG. 1, appropriately programmed in accordance with this specification, can perform the process 200.

For each time step in a sequence of time steps, the system obtains features representing an observation (step 202). The features can either be in the observation or the system can generate the features by processing the observation using a feature encoder. The observation characterizes a current state of the environment at the time step.

The observation can be represented as a set of features that characterize the environment. Each feature can be represented, e.g., as one or more numerical values. For example, for an observation that includes an image, the set of features representing the observation can include a respective feature representing the intensity of each channel of each pixel of the image. As another example, for an observation that includes joint position data for a mechanical agent, the set of features representing the observation can include a respective feature representing the position/angle of one or more joints of the mechanical agent.

For each of one or more auxiliary prediction neural networks, the system determines an auxiliary input to the auxiliary prediction neural network (step 204). The auxiliary input includes a proper subset of the set of features of the current observation. Each auxiliary prediction neural network corresponds to a target feature from the set of features from the observation. Each auxiliary prediction neural network is associated with a respective proper subset of features. The features in the respective proper subset of features can be different for different auxiliary prediction neural networks. To generate the input to a given auxiliary prediction neural network, the system selects, from the features in the observation, the features that are in the corresponding proper subset of features for the auxiliary prediction neural network.

For each of one or more auxiliary prediction neural networks, the system processes the auxiliary input for the auxiliary prediction neural network using the auxiliary prediction neural network (step 206). Each auxiliary prediction neural network is configured to generate a state value estimate for the current state of the environment relative to a corresponding auxiliary reward that measures values of a corresponding target feature from the set of features in the observations for the sequence of time steps.

In some implementations, for each time step in the sequence of time steps, the system can determine, for each auxiliary prediction neural network, the auxiliary reward for the time step based on the value of the corresponding target feature at the time step. The system can train each auxiliary prediction neural network based on the corresponding auxiliary rewards.

The system uses an action selection neural network to process an input to generate an action selection output (step 208). The input comprises a respective intermediate output generated by each auxiliary neural network at the time step.

In some implementations, the input to the action selection neural network can also include the observation for the time step.

In some implementations, the system can generate for each auxiliary prediction neural network, a respective state value estimate for the current state of the environment relative to the corresponding auxiliary reward. The system can provide the respective state value estimate generated by each auxiliary prediction network as additional input to the action selection neural network.

The action selection output, for example, can include a respective score for each action in a set of actions.

The system selects the action to be performed by the agent at the time step using the action selection output (step 210). For example, when the action selection output includes a respective score for each action in a set of actions, the system can select the action having the highest score to be performed by the agent.

In some implementations, the system can additionally receive a respective main task reward for each time step in the sequence of time steps. The system can train the action selection neural network based on the main task rewards using reinforcement learning techniques. The system can jointly train the one or more auxiliary prediction neural networks and the action selection neural network to maximize the main task rewards on some or all of the same data. The system trains the auxiliary prediction neural networks on an objective that measures errors between predicted state value estimates and ground truth state value estimates

In some implementations, the system can train the state value function using a regression loss between predicted state value estimates and ground truth state value estimates.

FIG. 3 is a flow diagram of an example process 300 for updating target features and proper subsets of features for auxiliary neural networks. For convenience, the process 300 will be described as being performed by a system of one or more computers located in one or more locations. The system includes one or more auxiliary prediction neural networks. For example, a reinforcement learning system, e.g., the reinforcement learning system 100 of FIG. 1, appropriately programmed in accordance with this specification, can perform the process 300.

The system, at every M time steps in the sequence of time steps, updates data that defines the respective target features that specify the auxiliary rewards for the auxiliary prediction neural networks (step 302). M is an integer that is greater than or equal to 1. The system can determine, for each feature in the set of features, a respective second importance score characterizing an importance of the feature to predicting main task rewards. The system can update data that defines the respective target features that specify the auxiliary rewards for the auxiliary prediction neural networks based on the second importance scores.

In some implementations, the system can determine the respective second importance score by obtaining a main task reward estimation function. The main task reward estimation function can be configured to process the set of features included in an observation for a time step to generate a prediction for a main task reward received at a next time step. For example, the main task reward estimation function can be a linear function that includes a respective parameter corresponding to each feature in the set of features. The system can determine the second importance score for each feature based on a value of the corresponding parameter of the main task reward estimation function.

In some implementations, the system can use a supervised learning technique to train the main task reward estimation function for the time step.

At every N time steps in a sequence of time steps, the system updates data that defines the proper subset of the set of features that are designated to be included in the auxiliary input to an auxiliary prediction neural network (step 304). N is an integer that is greater than or equal to 1. The system can determine for each feature in the set of features, a respective first importance score characterizing an importance of the feature to predicting state values relative to the auxiliary reward. The system can then update the data defining the proper subset of the set of features that are designated to be included in the auxiliary input to the auxiliary prediction neural network based on the first importance scores.

In some implementations, the system can determine the respective first importance score for each feature in the set of features by obtaining a state value function that is configured to process the set of features to generate a state value estimate for the current state of the environment relative to the corresponding auxiliary reward. The system can determine the first importance score for each feature in the set of features using the state value function.

For example, the state value function can be a linear function that includes a respective parameter corresponding to each feature in the set of features. The system can determine the first importance score for each feature based on a value of the corresponding parameter of the state value function. The state value function can be a weighted sum of the features, where the weight for each feature is the parameter that corresponds to the feature.

In some implementations, the system can train the state value function using a regression loss between predicted state value estimates and ground truth state value estimates.

A state value estimate can define the value of the current state of the environment relative to a corresponding auxiliary reward. For example, a state value estimate can define an estimate of a cumulative measure of the corresponding auxiliary reward for an auxiliary prediction neural network to be received over future time steps. As a particular example, the cumulative measure of the corresponding auxiliary reward can include a time-discounted sum of the corresponding auxiliary rewards.

The state value function can be defined by a tuple (C, γ, π) that includes a time varying cumulant signal C, a discount factor γ, and a policy π. A cumulant can refer to a numerical (e.g., scalar) valued time step-specific signal from the environment that can be used, e.g., in the place of an external reward (as will be described in more detail below). The time varying cumulant signal C at a particular time step is a function of the state at that time step such that Cₜ=C(Sₜ). A cumulant C for an auxiliary prediction neural network can be a target feature at a particular time step. The return at time t can be defined as the discounted sum of future cumulants while following the policy:

Gₜ^{C,γ π}=Cₜ₊₁+γCₜ₊₂+γ²C_{t+3+ . . .} ,

The discount factor γ is predetermined for the main task return and for the auxiliary returns. The discount factor γ can have the same value for all auxiliary prediction neural networks in the system. In some examples, the discount factor γ for the action selection neural network can have the same value as the discount factors for the auxiliary neural networks. In other examples, the discount factor γ for the action selection neural network can have a different value from the discount factors for the auxiliary neural networks. The system can be configured to use a predetermined the discount factor γ for a particular auxiliary prediction neural network as a value between [0,1] e.g., 0, 0.32, 0.45, 0.70 or 0.99.

In some implementations, prior to the first time step in the sequence of time steps, the system can randomly sample a feature from the set of features. The system can designate the randomly sampled feature as the target feature corresponding to an auxiliary prediction neural network. The target features can be updated at each time step after the first time step using the second importance score as described above.

In some implementations, prior to the first time step in the sequence of time steps, the system can select a proper subset of the set of features to be included in the auxiliary input to an auxiliary prediction neural network. The system can randomly sample a proper subset of the set of features. The system can designate the randomly sampled proper subset of the set of features for inclusion in the auxiliary input to the auxiliary prediction neural network. The proper subset of features can be updated at each time step after the first time step using the first importance score as described above.

FIG. 4A illustrates an example of selecting a subset of features based on the importance of the feature to predicting a reward. The example process can be performed by a feature selection system.

FIG. 4A shows a set 402 of features, a value function estimate 406, a value function objective 404, and a subset 408 of k features. In some examples, the system can selects k target features that can be associated with k given auxiliary prediction neural networks using the illustrated process.

The value function objective 404 can be a reward estimation function that generates a value function estimate 406 for the current state of the environment. The value function objective 404 can be a general value function (GVF) question and be defined by a tuple (C, γ, π) that includes a time varying cumulant signal C, a discount factor γ, and a policy π. The value function objective 404 can be a GVF question that is a one step reward where the cumulant C is set to an external reward and the discount factor γ=0.

The system performs an operation that selects the subset 408 of k features based on the utility of the individual features in the set 402 of features in predicting the value function estimate 406. The system selects a set of k features that are given a highest importance score for predicting the value function estimate 406.

In some examples, the system defines the utility as the magnitude of the weight associated with a feature when the value function objective 404 is a linear function. The value function estimate 406 can be can be calculated as a dot product between a vector of the set of features and a vector of the weights of the linear function. The value function estimate can be written as V(x;w)=w^{T}x=v^{C, π, γ}(s), where x is a feature vector associated with the state s.

The utility of a feature i can be denoted as |w[i]|. The system can select the k features with the highest utility and store them as a list of indices L. The system can use the list of indices to form a new feature vector x[L] of length k.

FIG. 4B shows the updated feature vector 408 of length k that is now populated with the k most important features for the value function objective 404. When the system uses the illustrated process to update target features for k auxiliary prediction neural networks, these k most important features can each correspond to k auxiliary prediction neural networks.

In some implementations, the process of selecting the k features with the highest utility can be incremental. The feature vector 408 of length k can be initialized to include random features or features from a previous time step. For the current time step, the system can swap the feature with the lowest importance score in the initialized feature vector with an unselected feature in the set 402 of features. The unselected feature that is swapped into the feature vector can be the feature with the highest importance score that was not previously included in the feature vector 408. In some implementations, the system can be configured to swap features only when the importance score of the unselected feature is higher than a predetermined threshold.

FIG. 5 shows an example 500 of updating the data defining respective target features for one or more auxiliary prediction neural networks.

FIG. 5 shows a main value function objective 504, a set of features 502, a subset of target features 508, and a set of new value function objectives 510. The set of new value function objective 510 can define subproblems of the main value function objective 504.

The main value function objective 504 can be a GVF question that is a one timestep prediction of external reward e.g., GVF^{Reward}=(Rₜ₊₁, 0, π_{b}), where π_{b} is a behavior policy. Using the example process of FIGS. 4A and 4B, the system can determine a subset of h target features 508 at each time step.

The system can use the selected h target features to a set of define new GVF questions 510. The new GVF questions can use the target features as cumulants. This allows the system to define its own components and subproblems. These new value function objectives describe target features that each correspond to an auxiliary prediction neural network. The system can use the new value function objectives to determine the features that should be included in the input to each auxiliary prediction neural network as a proper subset of features.

FIG. 6 shows an example 600 of updating the data that defines a proper subset of features for one or more auxiliary prediction neural networks.

The example 600 includes a set of features 502, a set of h auxiliary prediction neural networks 610, and a main value function objective 504. Each auxiliary prediction neural network 610 is associated with a new value function objective 608 that defines a subproblem of the main value function objective 504, and includes a value function estimate 602, a proper subset 606 of g features, and a vector 604 of d nonlinear features. The proper subset 606 of g features can be represented as a vector. The d nonlinear features can be an intermediate output of the auxiliary neural network and the system can provide the d nonlinear features 604 as an input to an action selection neural network. Optionally, the system can also provide the value function estimate 602 as input to an action selection neural network. Each new value function objective 608 is associated with a target feature, where each target feature is associated with an auxiliary prediction neural network.

The system follows the feature selection process described with reference to FIGS. 4A and 4B to identify the proper subset 606 of the g features with the highest importance for each value function objective. The architecture can additionally include a neural network e.g., a multilayer perceptron that can construct a vector 604 of d nonlinear features for the subproblem. The system can concatenate the d nonlinear features with the g linear features to form a full feature vector. The system can then use a dot product between the full feature vector and a vector of the weights of a linear function to calculate the value function estimate 602.

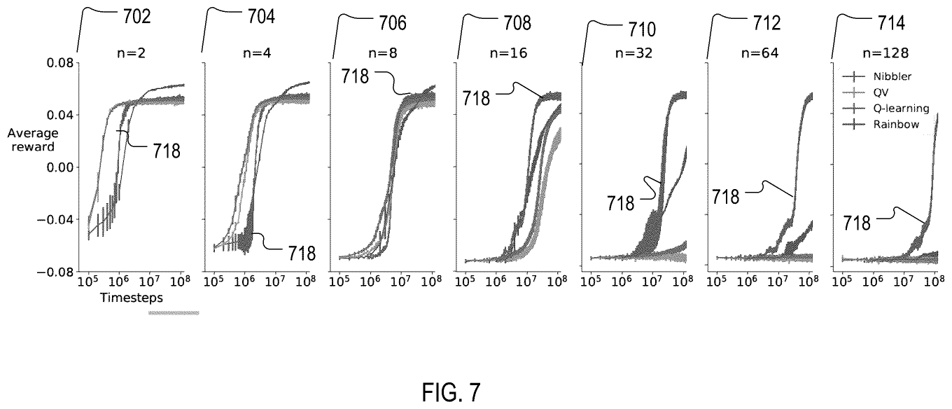

FIG. 7 show a series of graphs illustrating the performance of the process 200 of FIG. 2 compared to other methods on various environment sizes. For convenience, the process 200 of FIG. 2 will be referred to as the new algorithm. FIG. 7 shows seven graphs 702, 704, 706, 708, 710, 712, and 714 that each measure a number of time steps on the horizontal axis and average reward on the vertical axis and are each associated with a different environment sizes n. The graphs 702, 704, 706, 708, 710, 712, and 714 are associated with environment sizes n=2, n=4, n=8, n=16, n=32, n=64, and n=128 respectively. The line labeled 718 represents the performance of the method described in this specification.

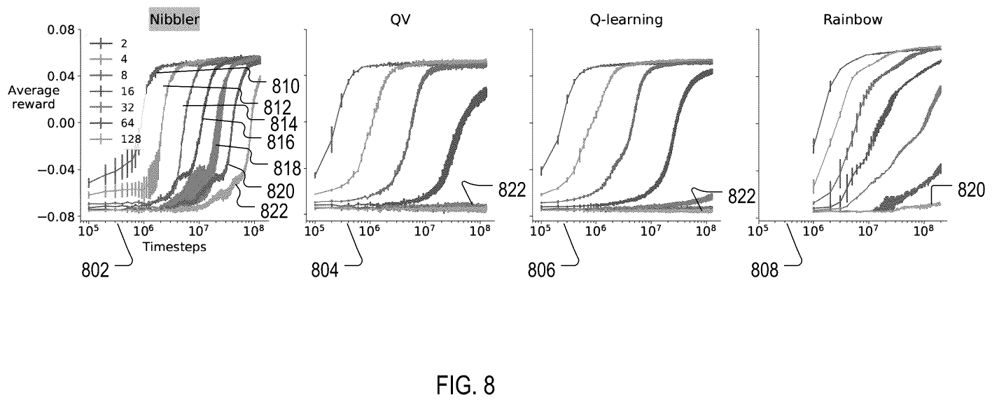

FIG. 8 shows another series of graphs illustrating the performance of the process 200 of FIG. 2 compared to other methods on various environment sizes. FIG. 8 shows four graphs 802, 804, 806, and 808 that each measure a number of time steps on the horizontal axis and average reward on the vertical axis. The leftmost graph 802 is associated with the new algorithm while the other graphs 804, 806, and 808 are each associated with other reinforcement learning algorithms with incremental deep function approximation. Each graph 802, 804, 806, and 808 show seven trendlines 810, 812, 814, 816, 818, 820, and 822 each representing the performance of the algorithm on environment sizes n=2, n=4, n=8, n=16, n=32, n=64, and n=128 respectively.

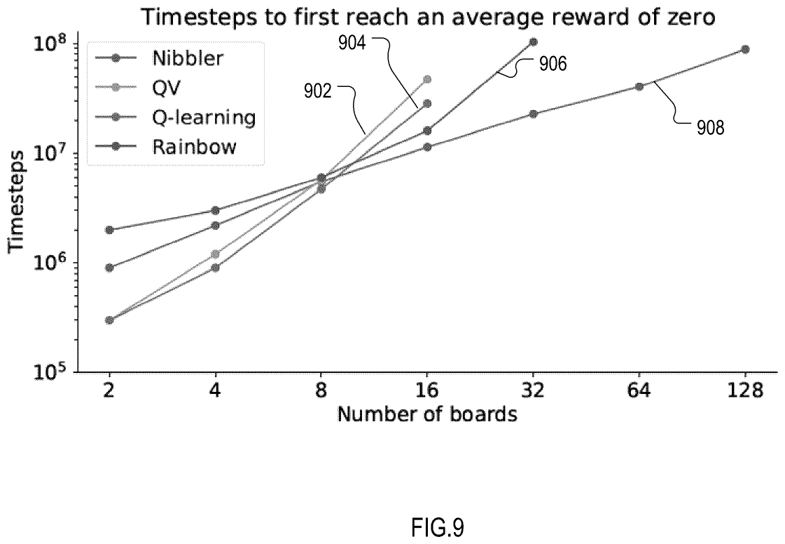

FIG. 9 shows another graph illustrating the performance of the process 200 of FIG. 2 compared to other methods on various environment sizes. FIG. 9 shows a graph that measures the size of the environment on the horizontal axis and the number of timesteps it takes to get a first average reward of zero on the vertical axis. The graph shows three trendlines 902, 904, and 906 that represent the performance of other reinforcement learning algorithms with incremental deep function approximation and one trendline 908 that represents the performance of the new algorithm. The new algorithm scales well to larger environment sizes compared to other algorithms.

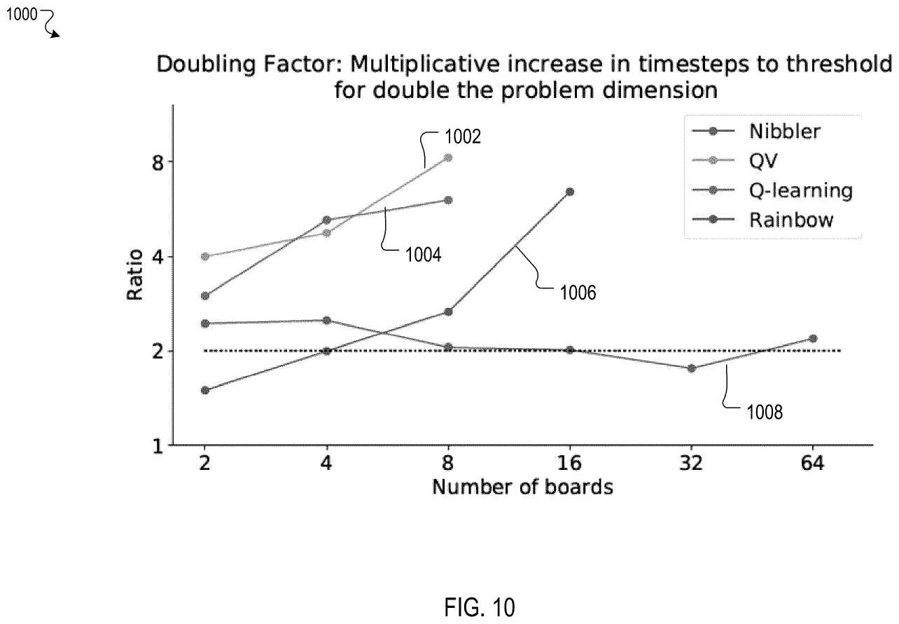

FIG. 10 shows another graph illustrating the performance of the process 200 of FIG. 2 compared to other methods on various environment sizes. FIG. 10 shows a graph that measures the size of the environment on the horizontal axis and the multiplicative increase in time steps to threshold for double the problem dimension. The horizontal axis measures the timestep doubling ratio. The graph shows three trendlines 1002, 1004, and 1006 the represent the performance of other reinforcement learning algorithms with incremental deep function approximation and one trendline 1008 that represents the performance of the new algorithm.

The experimental results described with reference to FIG. 7-FIG. 10 provide an illustration of certain advantages that can be achieved by the methods described in this specification.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors, or both, and any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers for selecting actions to be performed by an agent to interact with an environment to perform a main task, the method comprising, for each time step in a sequence of time steps:
receiving a set of features representing an observation, wherein the observation characterizes a current state of the environment at the time step;
for each of one or more auxiliary prediction neural networks:
determining an auxiliary input to the auxiliary prediction neural network, wherein the auxiliary input comprises a proper subset of the set of features representing the current observation;
processing the auxiliary input using the auxiliary prediction neural network, wherein:
the auxiliary prediction neural network is configured to generate a state value estimate for the current state of the environment relative to a corresponding auxiliary reward that measures values of a corresponding target feature from the set of features representing the observations for the sequence of time steps;
processing an input comprising a respective intermediate output generated by each auxiliary neural network at the time step using an action selection neural network to generate an action selection output; and
selecting the action to be performed by the agent at the time step using the action selection output.

2. The method of claim 1, wherein for each auxiliary prediction neural network, the state value estimate for the current state of the environment relative to the corresponding auxiliary reward defines an estimate of a cumulative measure of the corresponding auxiliary reward to be received over future time steps.

3. The method of claim 2, wherein for each auxiliary prediction neural network, the cumulative measure of the corresponding auxiliary reward comprises a time-discounted sum of the corresponding auxiliary rewards.

4. The method of claim 1, further comprising:
receiving a respective main task reward for each time step in the sequence of time steps; and
training the action selection neural network based on the main task rewards using reinforcement learning.

5. The method of claim 1, further comprising:
for each time step in the sequence of time steps:
determining, for each auxiliary prediction neural network, the auxiliary reward for the time step based on the value of the corresponding target feature at the time step; and
training each auxiliary prediction neural network based on the corresponding auxiliary rewards using reinforcement learning.

6. The method of claim 1, further comprising, at each of one or more time steps in the sequence of time steps:
updating, for one or more of the auxiliary prediction neural networks, data that defines the proper subset of the set of features that are designated to be included in the auxiliary input to the auxiliary prediction neural network.

7. The method of claim 6, wherein updating the data that defines the proper subset of the set of features that are designated to be included in the auxiliary input to an auxiliary prediction neural network comprises:
determining, for each feature in the set of features, a respective first importance score characterizing an importance of the feature to predicting state values relative to the auxiliary reward; and
updating the data defining the proper subset of the set of features that are designated to be included in the auxiliary input to the auxiliary prediction neural network based on the first importance scores.

8. The method of claim 7, wherein determining the respective first importance score for each feature in the set of features comprises:
obtaining a state value function that is configured to process the set of features to generate a state value estimate for the current state of the environment relative to the corresponding auxiliary reward; and
determining the first importance score for each feature in the set of features using the state value function.

9. The method of claim 8, wherein the state value function is a linear function that comprises a respective parameter corresponding to each feature in the set of features, and wherein determining the first importance score for each feature in the set of features using the state value function comprises:
determining the first importance score for each feature based on a value of the corresponding parameter of the state value function.

10. The method of claim 8, wherein for each time step in the sequence of time steps, the state value function is trained based on the auxiliary reward for the time step using reinforcement learning.

11. The method of claim 1, further comprising, at each of one or more time steps:
updating data that defines the respective target features that specify the auxiliary rewards for the auxiliary prediction neural networks.

12. The method of claim 11, wherein updating the data that defines the respective target features that specify the auxiliary rewards for the auxiliary prediction neural networks comprises:
determining, for each feature in the set of features, a respective second importance score characterizing an importance of the feature to predicting main task rewards; and
updating data that defines the respective target features that specify the auxiliary rewards for the auxiliary prediction neural networks based on the second importance scores.

13. The method of claim 12, wherein determining the respective second importance score for each feature in the set of features comprises:
obtaining a main task reward estimation function that is configured to process the set of features representing an observation for a time step to generate a prediction for a main task reward received at a next time step; and
determining the second importance score for each feature in the set of features using the main task reward estimation function.

14. The method of claim 13, wherein the main task reward estimation function is a linear function that comprises a respective parameter corresponding to each feature in the set of features, and wherein determining the second importance score for each feature in the set of features using the main task reward estimation function comprises:
determining the second importance score for each feature based on a value of the corresponding parameter of the main task reward estimation function.

15. The method of claim 13, wherein for each time step in the sequence of time steps, the main task reward estimation function is trained based on the main task reward for the time step using supervised learning.

16. The method of claim 1, wherein:
each auxiliary prediction neural network generates a respective state value estimate for the current state of the environment relative to the corresponding auxiliary reward; and
the input to the action selection neural network further comprises the respective state value estimate generated by each auxiliary prediction neural network.

17. The method of claim 1, further comprising, prior to the first time step in the sequence of time steps and for each auxiliary prediction neural network:
selecting a proper subset of the set of features to be included in the auxiliary input to the auxiliary prediction neural network, comprising:
randomly sampling a proper subset of the set of features; and
designating the randomly sampled proper subset of the set of features for inclusion in the auxiliary input to the auxiliary prediction neural network.

18. The method of claim 1, further comprising, prior to the first time step in the sequence of time steps and for each auxiliary prediction neural network:
randomly sampling a feature from the set of features; and
designating the randomly sampled feature as the target feature corresponding to the auxiliary prediction neural network.

19. A system comprising:
one or more computers; and
one or more storage devices communicatively coupled to the one or more computers, wherein the one or more storage devices store instructions that, when executed by the one or more computers, cause the one or more computers to perform operations for selecting actions to be performed by an agent to interact with an environment to perform a main task, the operations comprising, for each time step in a sequence of time steps:
receiving a set of features representing an observation, wherein the observation characterizes a current state of the environment at the time step;
for each of one or more auxiliary prediction neural networks:
determining an auxiliary input to the auxiliary prediction neural network, wherein the auxiliary input comprises a proper subset of the set of features representing the current observation;
processing the auxiliary input using the auxiliary prediction neural network, wherein:
the auxiliary prediction neural network is configured to generate a state value estimate for the current state of the environment relative to a corresponding auxiliary reward that measures values of a corresponding target feature from the set of features representing the observations for the sequence of time steps;
processing an input comprising a respective intermediate output generated by each auxiliary neural network at the time step using an action selection neural network to generate an action selection output; and
selecting the action to be performed by the agent at the time step using the action selection output.

20. One or more non-transitory computer storage media storing instructions that when executed by one or more computers cause the one or more computers to perform operations for selecting actions to be performed by an agent to interact with an environment to perform a main task, the operations comprising, for each time step in a sequence of time steps:
receiving a set of features representing an observation, wherein the observation characterizes a current state of the environment at the time step;
for each of one or more auxiliary prediction neural networks:
determining an auxiliary input to the auxiliary prediction neural network, wherein the auxiliary input comprises a proper subset of the set of features representing the current observation;
processing the auxiliary input using the auxiliary prediction neural network, wherein:
the auxiliary prediction neural network is configured to generate a state value estimate for the current state of the environment relative to a corresponding auxiliary reward that measures values of a corresponding target feature from the set of features representing the observations for the sequence of time steps;
processing an input comprising a respective intermediate output generated by each auxiliary neural network at the time step using an action selection neural network to generate an action selection output; and
selecting the action to be performed by the agent at the time step using the action selection output.
